(19) United States
(12) Patent Application Publication
(10) Pub. No.: US 2024/0125068 A1
(43) Pub. Date: Apr. 18, 2024

(54) SHARK-ATTACK-PREVENTION OCEAN WALL DEVICE

(71) Applicant: Darryl Lee, Harrisburg, PA (US)

(72) Inventor: Darryl Lee, Harrisburg, PA (US)

(21) Appl. No.: 18/363,235

(22) Filed: Aug. 1, 2023

Related U.S. Application Data
(60) Provisional application No. 63/415,751, filed on Oct. 13, 2022.

(51) Int. Cl. E02B 1/00; A01M 29/30; B63C 9/00

(52) U.S. Cl. CPC E02B 1/006; A01M 29/30; B63C 9/00; B63C 2009/0088

(57) ABSTRACT

A shark-attack-prevention ocean wall device is provided. The device is comprised of a post and net system that can be anchored into an ocean floor and provides a vertical net barrier. The barrier can be erected around a specific area of an ocean or other body of water to provide a swimming area free of dangerous animals, such as but not limited to sharks.

### CROSS-REFERENCE TO RELATED APPLICATION

The present application claims priority to, and the benefit of, U.S. Provisional Application No. 63/415,751, which was filed on Oct. 13, 2022, and is incorporated herein by reference in its entirety.

### FIELD OF THE INVENTION

The present invention relates generally to the field of shark attack prevention devices. More specifically, the present invention relates to a shark-attack prevention ocean wall device that can be planted into the floor of the ocean to form a barrier around a specific section of the ocean. Within this barrier, a net of the device ensures sharks and other animals cannot enter said area while individuals are swimming. Accordingly, the present disclosure makes specific reference thereto. Nonetheless, it is to be appreciated that aspects of the present invention are also equally applicable to other like applications, devices, and methods of manufacture.

### BACKGROUND

Swimming in the ocean can be dangerous due to sharks and other animals being present in the water. Shark attacks are incredibly dangerous and can lead to severe injury and even death. As a result, individuals may avoid swimming in the ocean entirely due to fear of shark attacks. This is undesirable, as all individuals should be able to safely experience the ocean.

Therefore, there exists a long-felt need in the art for a device that keeps users safe from shark attacks while swimming in the ocean. There also exists a long-felt need in the art for a shark-attack-prevention ocean wall device that can be removably installed within the ocean and that prevents sharks from attacking individuals swimming in the ocean. More specifically, there exists a long-felt need in the art for a shark-attack-prevention ocean wall device that can be removably installed within the ocean and that prevents sharks from attacking individuals swimming in the ocean by creating a secure area within the ocean.

The subject matter disclosed and claimed herein, in one embodiment thereof, comprises a shark-attack-prevention ocean wall device. The device is comprised of at least one post and at least one net that attaches to the post. In the preferred embodiment, a plurality of posts are driven into an ocean (or other body of water) floor. Then, a plurality of nets are attached between each post, wherein the nets extend from the ocean floor to (or above) the ocean water line. In this manner, a barrier is created that prevents sharks (or other dangerous animals) from swimming into a portion of the water, in which individuals can safely swim. In one embodiment, the net and/or posts may be comprised of at least one marker to alert swimmers to the presence of said structures in the water.

In this manner, the shark-attack-prevention ocean wall device of the present invention accomplishes all the forgoing objectives and provides a device that keeps users safe from shark attacks while swimming in the ocean. To do so, the device can be removably installed within the ocean. More specifically, the device can be removably installed within the ocean to create a secure area within the ocean that prevents sharks from attacking individuals swimming within the area.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a shark-attack-prevention ocean wall device intended to be used in an ocean (or other body of water) setting to protect swimmers from sharks (among other dangerous animals) while swimming in an ocean. The device is primarily comprised of at least one vertical post and at least one netting that attaches to the post. The post is comprised of a first end and a second end. In one embodiment, the first end is comprised of at least one marker that alerts a swimmer to the presence of the post while swimming.

The device is also comprised of at least one net that attaches to the post. The net may be any net type known in the art. The net may have a weighted bottom edge that prevents the net from moving during use. The top edge of the net may also be comprised of at least one fixedly or removably attached marker to alert users of the position of the net.

The net attaches to the side surface of the post during use. In different embodiments, the net may attach to the side surface via at least one fastener of the post which attaches to the net. In a different embodiment, the fastener of the post attaches to at least one fastener of the net, wherein both fasteners are any type of reciprocating fasteners known in the art.

The present invention is also comprised of a method of using the device. First, a device is provided comprised of at least one vertical post and at least one net. Then, the second end of the post is driven into the ocean floor to secure the post vertically (i.e., perpendicular to the ocean floor). Next, the net can be attached to at least one fastener of the post to create a barrier from the ocean floor to the surface of the water.

In a second method of use, a device is provided comprised of at least one vertical post comprised of at least one fastener and at least one net comprised of at least one fastener. Then, the second end of the post is driven into the ocean floor to secure the post vertically (i.e., perpendicular to the ocean floor). Next, the fastener of the net can be attached to the fastener of the post to create a barrier from the ocean floor to the surface of the water.

Accordingly, the shark-attack-prevention ocean wall device of the present invention is particularly advantageous as it provides a device that keeps users safe from shark attacks while swimming in the ocean. To do so, the device can be removably installed within the ocean. More specifically, the device can be removably installed within the ocean to create a secure area within the ocean that prevents sharks from attacking individuals swimming within the area. In this manner, the shark-attack-prevention ocean wall device provides a solution to swimming safely in the ocean.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a shark-attack-prevention ocean wall device of the present invention while secured in an ocean floor in accordance with the disclosed architecture;

FIG. 2 illustrates a perspective view of a post and net connection of one potential embodiment of a shark-attack-prevention ocean wall device of the present invention in accordance with the disclosed architecture;

FIG. 3 illustrates a perspective view of a post and net connection of one potential embodiment of a shark-attack-prevention ocean wall device of the present invention in accordance with the disclosed architecture;

FIG. 4 illustrates a perspective view of one potential embodiment of a shark-attack-prevention ocean wall device of the present invention while secured in an ocean floor in accordance with the disclosed architecture;

FIG. 5 illustrates a flowchart of a method of using one potential embodiment of a shark-attack-prevention ocean wall device of the present invention in accordance with the disclosed architecture; and

FIG. 6 illustrates a flowchart of a method of using one potential embodiment of a shark-attack-prevention ocean wall device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that keeps users safe from shark attacks while swimming in the ocean. There also exists a long-felt need in the art for a shark-attack-prevention ocean wall device that can be removably installed within the ocean and that prevents sharks from attacking individuals swimming in the ocean. More specifically, there exists a long-felt need in the art for a shark-attack-prevention ocean wall device that can be removably installed within the ocean and that prevents sharks from attacking individuals swimming in the ocean by creating a secure area within the ocean.

The present invention, in one exemplary embodiment, is comprised of a shark-attack-prevention ocean wall device. The device can be used in an ocean (or other body of water) setting to protect swimmers from sharks (among other dangerous animals) while swimming in an ocean. The device is primarily comprised of at least one vertical post and at least one netting that attaches to the post that is used to form a barrier from an ocean floor to (or above) a water line. The post is comprised of a first end and a second end, wherein the first end is comprised of at least one marker that alerts a swimmer to the presence of the post while swimming.

The device is also comprised of at least one net that attaches to the post. The net may be any net type known in the art. The net may have a weighted bottom edge that prevents the net from moving during use. The top edge of the net may also be comprised of at least one fixedly or removably attached marker to alert users of the position of the net.

The net attaches to the side surface of the post during use. In different embodiments, the net may attach to the side surface via at least one fastener of the post which attaches to the net. In a different embodiment, the fastener of the post attaches to at least one fastener of the net, wherein both fasteners are any type of reciprocating fasteners known in the art.

The present invention is also comprised of a method of using the device. First, a device is provided comprised of at least one vertical post and at least one net. Then, the second end of the post is driven into the ocean floor to secure the post vertically (i.e., perpendicular to the ocean floor). Next, the net can be attached to at least one fastener of the post to create a barrier from the ocean floor to the surface of the water.

In a second method of use, a device is provided comprised of at least one vertical post comprised of at least one fastener and at least one net comprised of at least one fastener. Then, the second end of the post is driven into the ocean floor to secure the post vertically (i.e., perpendicular to the ocean floor). Next, the fastener of the net can be attached to the fastener of the post to create a barrier from the ocean floor to the surface of the water.

Accordingly, the shark-attack-prevention ocean wall device of the present invention is particularly advantageous as it provides a device that keeps users safe from shark attacks while swimming in the ocean. To do so, the device can be removably installed within the ocean. More specifically, the device can be removably installed within the ocean to create a secure area within the ocean that prevents sharks from attacking individuals swimming within the area. In this manner, the shark-attack-prevention ocean wall device provides a solution to swimming safely in the ocean.

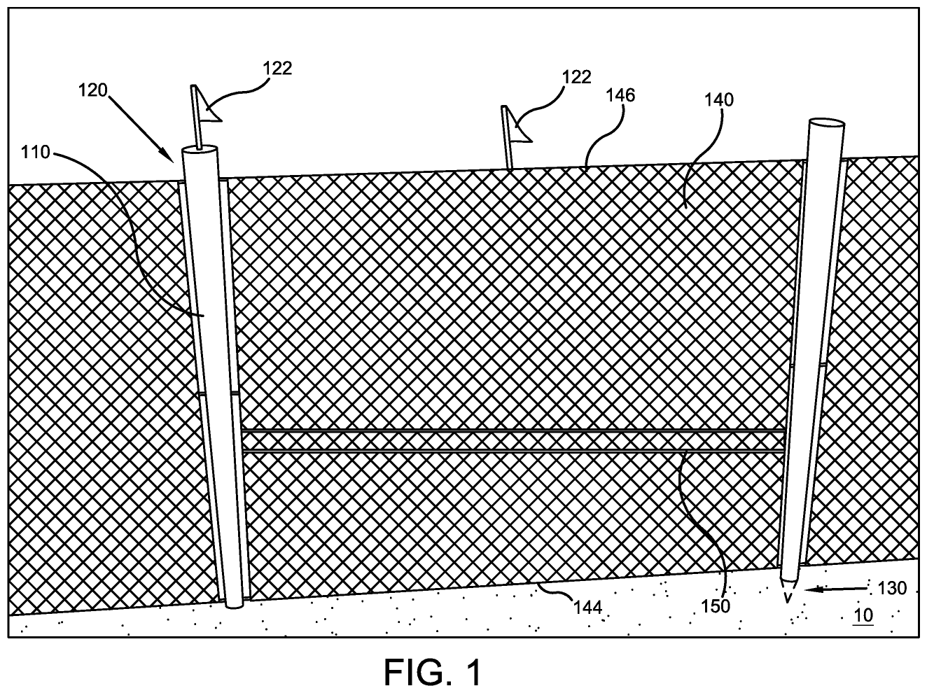

Referring initially to the drawings, FIG. 1 illustrates a perspective view of one potential embodiment of a shark-attack-prevention ocean wall device 100 of the present invention while secured in an ocean floor in accordance with the disclosed architecture. The device 100 is intended to be used in an ocean (or other body of water) setting to protect swimmers from sharks (among other dangerous animals) while swimming in an ocean by creating a barrier that extends from an ocean floor 10 to (or above) a water surface. The device 100 is primarily comprised of at least one vertical post 110 and at least one netting 140 that attaches to the post 110.

The post 110 may be comprised of a plurality of materials in different embodiments. Said materials include but are not limited to wood, metal, plastic, fiberglass, graphite, etc. or any combination known in the art. The post 110 may be any shape known in the art, and any height. However, the post 110 is preferably cylindrical, rectangular, or I-beam in shape.

More specifically, the post 110 is comprised of a first end 120 and a second end 130. In one embodiment, the first end 120 is comprised of at least one marker 122, as seen in FIG. 1. The marker 122 alerts a swimmer to the presence of the post 110 while swimming. The marker 122 may be in the form of a buoy, a flag, or any other marker known in the art. In one embodiment, the marker 122 may be reflective such that it can be easily seen at night. The marker 122 may also be found anywhere on the net 140, but preferably on the top edge 146 of the net 140 such that it can be seen by individuals in the water.

In one embodiment, the second end 130 is comprised of at least one point. The point allows the post 110 to easily penetrate the ocean floor 10. In another embodiment, the second end 130 may be flat.

The device 100 is also comprised of at least one net 140 that attaches to the post 110. The net 140 may be any net type known in the art. The net 140 is preferably a gillnet of any mesh size, color, and type.

The net 140 may have a weighted bottom edge 144 that prevents the net 140 from moving during use. The top edge 146 of the net 140 may also be comprised of at least one fixedly or removably attached marker 122 to alert users of the position of the net 140.

In one embodiment, any portion of the net 140 may be comprised of at least one cross bar support 150, as seen in FIG. 1. The support 150 provides horizontal or vertical support to the net 140. The support 150 is preferably made from the same material as the post 110. In one embodiment, the cross bar support 150 is removable from the net. In another embodiment, the cross bar support 150 is fixedly attached to the posts 110 on each side of a section of the net 140.

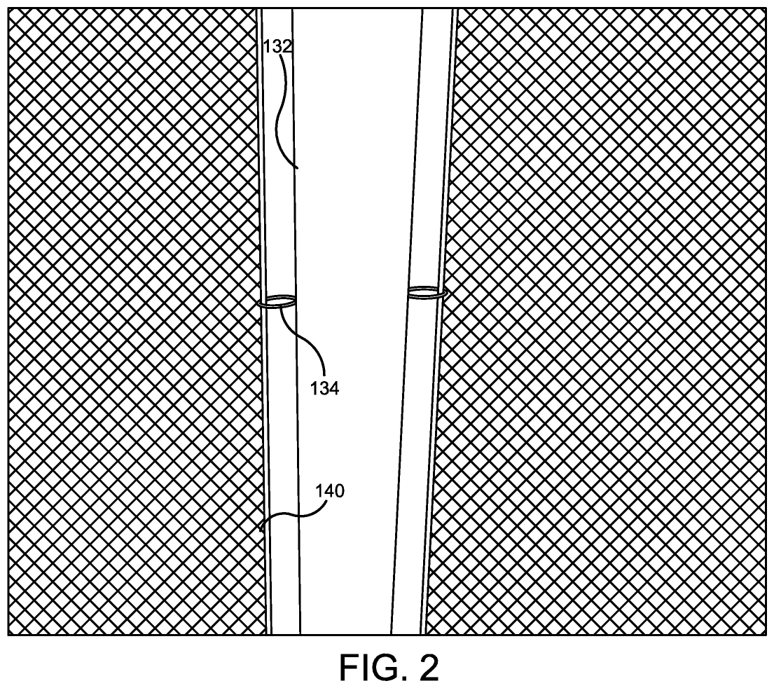

The net 140 attaches to the side surface 132 of the post 110. In different embodiments, the net 140 may attach to the side surface 132 in a plurality of ways. In one embodiment, the post 110 is comprised of at least one fastener 134 that attaches to the net 140, as seen in FIG. 2. Said fastener may include but is not limited to a clip, a clamp, or other fixed or removable connections known in the art.

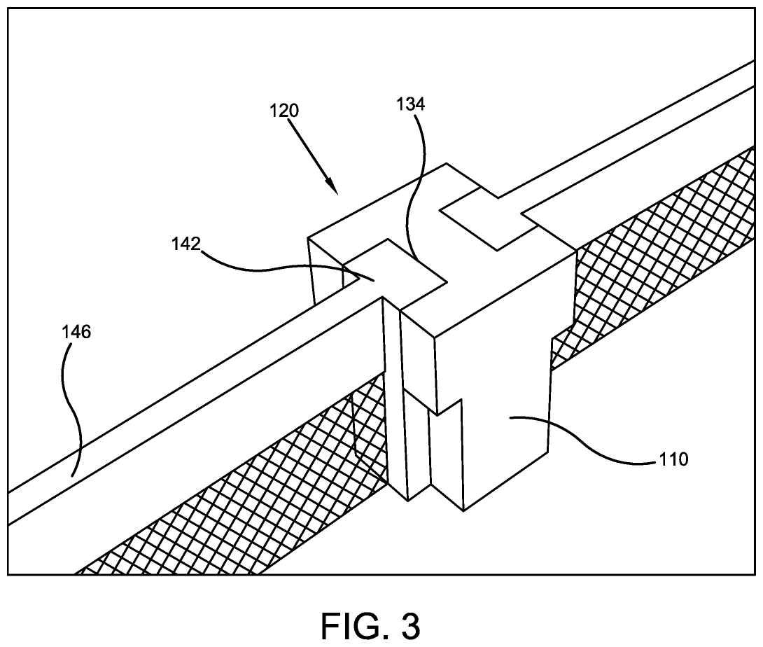

In a different embodiment, the fastener 134 attaches to at least one fastener 142 of the net 140, wherein both fasteners 134,142 are any type of reciprocating fasteners known in the art such as but not limited to tongue and groove (as seen in FIG. 3), clip and loop, bolt and threaded opening, etc.

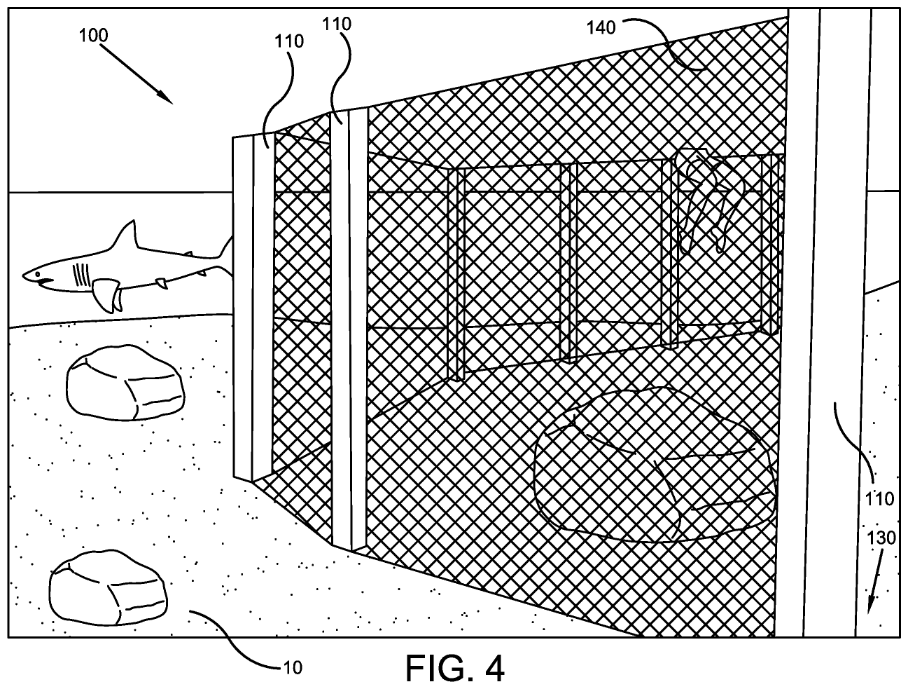

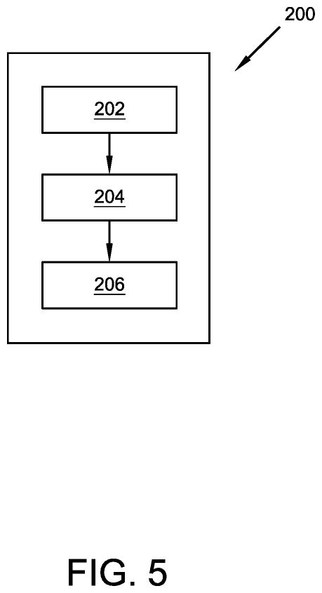

The present invention is also comprised of a method of using 200 the device 100, as seen in FIG. 5. First, a device 100 is provided comprised of at least one vertical post 110 and at least one net 140 [Step 202]. Then, the second end 130 of the post 110 is driven into the ocean floor 10 to secure the post 110 vertically (i.e., perpendicular to the ocean floor 10) [Step 204]. Next, the net 140 can be attached to at least one fastener 134 of the post 110 to create a barrier from the ocean floor 10 to the surface of the water, as seen in FIG. 4 [step 206].

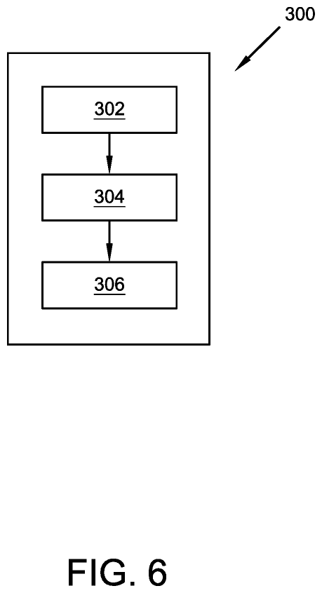

In a second method of using 300 the device 100 (as seen in FIG. 6), a device 100 is provided comprised of at least one vertical post 110 comprised of at least one fastener 134 and at least one net 140 comprised of at least one fastener 142 [Step 302]. Then, the second end 130 of the post 110 is driven into the ocean floor 10 to secure the post 110 vertically (i.e., perpendicular to the ocean floor 10) [Step 304]. Next, the fastener 142 of the net 140 can be attached to the fastener 134 of the post 110 to create a barrier from the ocean floor 10 to the surface of the water, as seen in FIG. 4 [step 306].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “shark-attack-prevention ocean wall device” and “device” are interchangeable and refer to the shark-attack-prevention ocean wall device 100 of the present invention.

Notwithstanding the forgoing, the shark-attack-prevention ocean wall device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the shark-attack-prevention ocean wall device 100 as shown in the FIGS. are for illustrative purposes only, and that many other sizes and shapes of the shark-attack-prevention ocean wall device 100 are well within the scope of the present disclosure. Although the dimensions of the shark-attack-prevention ocean wall device 100 are important design parameters for user convenience, the shark-attack-prevention ocean wall device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shark-attack-prevention ocean wall device comprising:
a post comprised of a fastener and a first marker; and
a net that attaches to the fastener of the post, the net comprised of a top edge and a bottom edge.

2. The shark-attack-prevention ocean wall device of claim 1, wherein the net is comprised of a support bar.

3. The shark-attack-prevention ocean wall device of claim 1, wherein the first marker is comprised of a buoy or a flag.

4. The shark-attack-prevention ocean wall device of claim 1, wherein the first marker is comprised of a reflective marker.

5. The shark-attack-prevention ocean wall device of claim 1, wherein the top edge of the net is comprised of a second marker.

6. The shark-attack-prevention ocean wall device of claim 5, wherein the second marker is comprised of a buoy or a flag.

7. The shark-attack-prevention ocean wall device of claim 5, wherein the second marker is comprised of a reflective marker.

8. The shark-attack-prevention ocean wall device of claim 1, wherein the net is comprised of a gillnet.

9. The shark-attack-prevention ocean wall device of claim 1, wherein the net is comprised of a weighted bottom edge.

10. The shark-attack-prevention ocean wall device of claim 1, wherein the fastener is comprised of a clip or a clamp.

11. A shark-attack-prevention ocean wall device comprising:
a post comprised of a first fastener and a marker; and
a net comprised of a second fastener that attaches to the first fastener of the post, the net comprised of a top edge and a bottom edge.

12. The shark-attack-prevention ocean wall device of claim 11, wherein a second end of the post is comprised of a pointed end.

13. The shark-attack-prevention ocean wall device of claim 11, wherein the first fastener and the second fastener are comprised of a pair of reciprocating fasteners.

14. The shark-attack-prevention ocean wall device of claim 13, wherein the first fastener is comprised of a bolt and the second fastener is comprised of a threaded opening.

15. The shark-attack-prevention ocean wall device of claim 13, wherein the first fastener is comprised of a tongue and the second fastener is comprised of a groove opening.

16. A method of using a shark-attack-prevention ocean wall device, the method comprising the following steps:
providing a shark-attack-prevention ocean wall device comprised of a vertical post comprised of a first fastener and a net;
driving a second end of the vertical post into an ocean floor; and
attaching the net to the vertical post via the first fastener.

17. The method of claim 16 further comprised of a step of attaching the net to vertical post by attaching a second fastener of the net to the first fastener of the post.

18. The method of claim 17, wherein the first fastener and the second fastener are comprised of a pair of reciprocating fasteners.

19. The method of claim 16, wherein the post is comprised of a first marker.

20. The method of claim 16, wherein the net is comprised of a second marker.
